(19) United States
(12) Patent Application Publication
(10) Pub. No.: US 2021/0031363 A1
(43) Pub. Date: Feb. 4, 2021

(54) ROTARY DRIVE DEVICE AND A ROBOT ARM OF A ROBOT WHICH IS PROVIDED THEREWITH

(71) Applicant: Festo SE & Co. KG, Esslingen (DE)

(72) Inventors: Jakob Brenner, Esslingen (DE); Mario Bauer, Weilheim an der Teck (DE)

(21) Appl. No.: 16/943,657

(22) Filed: Jul. 30, 2020

(30) Foreign Application Priority Data
Jul. 31, 2019 (DE) 10 2019 211 443.1

(51) Int. Cl. B25J 9/14; F16D 63/00; F16D 65/18; B25J 19/00; B25J 17/00

(52) U.S. Cl. CPC B25J 9/146; F16D 63/006; F16D 2121/06; B25J 19/0004; B25J 17/00; F16D 65/18

(57) ABSTRACT

A rotary drive device includes a rotary drive which is provided with a braking device and which has an output unit which can be driven into a rotary output movement about a rotation axis. The braking device has two braking bodies with braking structures which lie opposite one another and which by way of an actuation device are drivable into a relative switch-over movement in order to either block the output unit in a rotationally fixed manner or to release it for carrying out an output movement. The switch-over movement is effected in the axis direction of a brake rotation axis, about which the first braking body which is drivingly coupled to the output unit is rotatable. The second braking body is non-rotatably arranged on the drive housing. Furthermore, a robot arm which is provided with such a rotary drive device is suggested.

### BACKGROUND OF THE INVENTION

The invention relates to a rotary drive device, with a rotary drive which comprises a drive housing and an output unit which with respect to this is drivable into a rotary output movement about its longitudinal axis by way of drive components which are arranged in the drive housing, and with a device for the non-rotatable blocking of the output unit in different rotation positions.

The invention further relates to a robot arm of a robot which comprises at least two arm members which are connected to one another in a pivotable manner relative to one another by way of an arm joint.

A rotary drive device which is designed in the aforementioned context is known from DE 39 41 255 C2. It comprises a fluid-actuated rotary drive which has drive housing and an output unit which is rotatable relative to the drive housing. The output unit has an output shaft with an output section which lies outside the drive housing and which permits a force take-off. A pivoting piston which compartmentalises two drive chambers from one another and which is connected to the output unit in a rotationally fixed manner is located in the inside of the drive housing. The drive chambers can be controllably subjected to a fluid pressure medium, in order to create a pivoting movement of the pivoting piston and, resulting from this, a rotary output movement of the output unit. A device with which the output unit can be non-rotatably blocked in two rotation positions is assigned to an end section of the output shaft which is opposite the output section. This device is a stop device, with which a maximal rotation angle of the output unit can be set. A stop arm which interacts with two adjustable stops fastened to the drive housing at the outside and which is seated on the output shaft belongs to the stop device.

DE 10 2010 013 617 B4 discloses a modularly constructed robot which has a movable robot arm which is provided with at least one arm joint which connects two arm members which are movable relative to one another to one another. The arm joint is formed by a rotary drive device which comprises an electrically actuatable rotary drive.

DE 20 2014 010 781 U1 describes a rotary drive device which as a constituent of a construction machine is provided with a braking device. The rotary drive device has two components which are rotatable relative to one another, wherein an electrical drive device is responsible for generating the rotation movement. A braking unit which comprises a brake disc and two brake pads which interact with the brake disc is integrated between the two components.

DE 20 2011 103 223 U1 relates to a robot arm which is provided with a rotary drive device, wherein a brake is integrated into the rotary drive device, by way of which brake a rotatable output element is non-rotatably blockable.

A rotary drive which is described in DE 24 07 829 A has a compressed air motor as a drive device which drives a shaft which is rotatably coupled via a gear to an output shaft. An overload coupling is connected into the force train and comprises a sleeve-like coupling member which is arranged on the output shaft in an axially displaceable manner. If an overload situation occurs, annular braking plates which are arranged coaxially to one another are clamped to one another, so that the shaft is blocked in a non-rotatable manner.

U.S. Pat. No. 3,179,018 A describes a fluid-actuated rotary drive, wherein an annular braking element which comprises a brake lining is arranged on the shaft of an output unit in a rotationally fixed manner. An annular piston which is axially movable by way of a fluid and which can be pressed onto the braking element, in order to non-rotatably block the drive unit is arranged coaxially to be braking element.

### SUMMARY OF THE INVENTION

It is the object of the invention to provide a rotary drive device which is constructed in a compact and weight-saving manner, permits a variable blocking of the output unit and in particular is also suitable for realising a robot arm which comprises at least one arm joint.

With regard to a rotary drive device in combination with the initially mentioned features, for achieving this object one envisages the device for blocking the output unit being a braking device which is provided with an actuation device and whose operating state can be actively switched by way of the actuation device, between a release position which permits an unhindered rotation of the output unit and a blocking position which blocks the output unit in both directions in a non-rotatable manner, wherein the braking device comprises a first braking body which is provided with a first braking structure and which with regard to drive is coupled to the output unit and given the output movement of the output unit executes a rotation movement about a brake rotation axis, and wherein the braking device comprises a second braking body which comprises a second braking structure and which is arranged in a non-rotatable manner with respect to the drive housing wherein the second braking structure lies opposite the first braking structure in the axis direction of the brake rotation axis, wherein a relative switch-over movement between the two braking bodies in the axis direction of the brake rotation axis can be created by way of the actuation device, said switch-over movement effecting a switch-over of the operating state of the braking device and by way of which switch-over movement the two braking structures can be brought into braking engagement with one another or out of braking engagement for selectively creating the blocking position or the release position.

A robot arm of a robot which is according to the invention comprises at least one arm joint which connects two arm members to one another in a pivotable manner relative to one another and which is formed by at least one rotary drive device which is designed in the aforementioned context.

With regard to the rotary drive device according to the invention, the rotary drive is provided with a braking device, by way of which independently of the momentarily assumed rotation position of the output unit a non-rotatable blocking of the output unit with respect to the drive housing in both directions can be created in a releasable manner. The blocked output unit is neither rotatable relative to the drive housing in the clockwise direction nor in the anti-clockwise direction. The braking device comprises an actuation device which permits an active switch-over of the operating state of the braking device between a release position which permits the rotary output movement and a blocking position which prevents the output movement. Both positions can be maintained for as long as is desired. There therefore exits the advantageous possibility for securing the relative positions which are assumed between the output unit and the drive housing, not only in any end positions of the output movement but also in intermediate positions lying therebetween.

The braking device can be used for example in order to secure rotary relative positions between the output unit and the drive housing independently of the function of the rotary drive, so that the rotary drive can be relieved. This being for only a brief fixation of relative positions as well as for the purpose of a longer lasting fixation, for example during operating pauses of an appliance which is provided with the rotary drive device. The braking device comprises two braking bodies which each comprise a braking structure, wherein a first braking body which comprises the first braking structure is coupled to the output unit such that it takes part in the output movement of this, whereas a second braking body which comprises the second braking structure is arranged on the drive housing in a non-rotatable manner with respect to this. The two braking structures lie opposite one another in the axis direction of a rotation axis of the first braking body which is denoted as the brake rotation axis and about which the first braking body is rotated given a rotary output movement of the output unit. A switch-over movement can be created by way of the actuation device, concerning which movement it is the case of a relative movement between the two braking bodies which is orientated in the axis direction of the brake rotation axis and concerning which the two braking structures approach one another or distance themselves from one another depending on the movement direction. In this manner, the two braking structures can be selectively brought into a mutual braking engagement which creates the blocking position or however can be disengaged from one another for setting the release position. Given the switch-over movement, in principle both braking bodies can simultaneously carry out a movement relative to the drive housing or to the output unit. However, it is advantageous if the switch-over movement is only executed by one of the two braking bodies, and specifically in particular exclusively by the second braking body which is arranged on the drive housing.

Usefully, not only can the braking device be used to releasably block a relative position, set previously by way of the rotary drive, between the output unit and the drive housing, in both rotation directions, but also in order to cause a braking of the rotary output movement before the final blocking. In other words, the braking device at all events is suitable for use as a hand brake, and preferably also as a dynamic service brake.

Since the braking device can be integrated into the rotary drive device in a space-saving manner and with a low weight, the rotary drive device which is provided herewith is preferably suitable for integration into a moved system, for example into a robot arm of a robot for forming an arm joint. Such an arm joint can comprise for example a single rotary drive device according to the invention, wherein a fastening interface for fastening one of the arm members of the robot arm is formed on the output unit and on the drive housing. Concerning a likewise advantageous embodiment, two rotary drive devices are commonly grouped together into an arm joint in a manner such that their drive housings are non-rotatably fastened to one another, wherein one of two arm members which are to be pivoted relative to one another is fastened to each of the two output units.

Advantageous further developments of the invention are to be derived from the dependent claims.

Usefully, the output unit is drivable into a bi-directional rotary output movement between two end rotation positions, wherein the braking device is designed in a manner such that its operating state in both end rotation positions of the output unit as well as in a multitude of intermediate rotation positions of the output unit which lie between the two end rotation positions can be switched between the release position and the blocking position. An extremely high flexibility for the application of the rotary drive device is given on account of this.

The braking device can be designed in a manner such that its operating state can only be changed during a relative standstill between the output unit and the drive housing. However, an embodiment concerning which the operating state of the braking device can be switched over additionally also during the output movement is preferred. This opens up particularly variable application possibilities.

The rotationally movable output unit usefully has an output section which is accessible from outside the drive housing and which comprises at least one fastening interface which can be used for a force take-off. For example, a machine part which is to be rotated or pivoted, for example a robot arm or an end effector of a robot arm can be attached to the fastening interface. The output unit is preferably designed in a disc-like manner and in particular has a circular outer contour.

The rotation axis of the first braking body which is denoted as the brake rotation axis can be arranged offset to the rotation axis of the output unit in a parallel manner, if a gear connection is provided between these two constituents. An embodiment concerning which the brake rotation axis runs coaxially to the rotation axis of the output unit, so that the two rotation axes quasi coincide is seen as being particularly advantageous. This permits a particularly narrow construction manner of the rotary drive device in the direction which is at right angles to the rotation axis of the output unit.

The first braking body can be arranged separately from the output unit if for example it is coupled in movement to the output unit via a gear device. However, a construction form concerning which the first braking body is arranged directly on the output unit and in particular is fixedly connected to the output unit is preferred. The first braking body is preferably arranged on an output section of the output unit which permits a force take-off, wherein it is usefully designed as one piece with this output section. Preferably, the first braking body is located on a radially outwardly lying edge region of the output section, wherein it preferably extends coaxially to the rotation axis of the output unit annularly around the output unit.

A rotary drive device whose rotary drive is a fluid-actuated rotary drive is seen as being particularly useful, wherein a pneumatic rotary drive which is operated with compressed air is preferred. Such a fluid-actuated rotary drive usefully as one of the drive components has a pivoting piston which is arranged in a housing interior of the drive housing, is connected to the output unit is a rotationally fixed manner and compartmentalises two drive chambers from one another, said drive chambers being able to be subjected to a fluid pressure medium in a controlled manner, in order to create a pivoting movement of the pivoting piston, from which the rotary output movement of the output unit results.

In particular, the rotary drive is designed in order to selectively carry out a rotary output movement in the clockwise direction or counter to the clockwise direction, thus a bi-directional rotation. This is particularly in the context of a fluid-actuated rotary drive. The realisable rotation angle is hereby preferably somewhat less than 360 degrees.

With regard to an alternative embodiment, the rotary drive can also be an electrical rotary drive, for example an electrical stepper motor or servomotor. In this case too, an embodiment which permits a to and fro rotation movement is preferred.

Basically, the rotary drive can also be designed for executing only a unidirectional rotary output movement.

It is advantageous if the first braking structure as well as the second braking structure has a circular-arcuately curved longitudinal extension, wherein the centre of curvature lies on the brake rotation axis. If the rotation angles of the output movement which are required on use are relatively small, then the arc angle of the first braking structure and/or of the second braking structure can be less than 360 degrees.

It is seen as being particularly advantageous if, of the two braking structures, at least one braking structure is designed in an annulus-shaped manner, so that it extends over an arc angle of 360 degrees. Herein, it is seen as being advantageous if both braking structures are designed in an annulus-shaped manner and are arranged coaxially to the brake rotation axis.

The radial distance of the two braking structures to the brake rotation axis is usually equal amongst one another. This is particularly when the switch-over movement is a purely linear movement in the axis direction of the brake rotation axis. The relative switch-over movement is preferably a purely linear movement in the axis direction of the brake rotation axis, but can basically also be a non-linear movement which is composed of several movement components including a moment component which is orientated in the axis direction of the brake rotation axis, for example a pivoting movement.

The two braking structures in the case of one possible embodiment are each designed as at least essentially plane braking surfaces, wherein the mutual braking engagement lies in the braking surfaces being pressed flatly against one another. In this case, the resulting blocking force is a pure friction force. For example, the braking surfaces can consist of a temperature-resistant material with a high coefficient of friction, as is also applied with brake linings in vehicle technology.

A particularly preferred embodiment envisages each of the two braking structures being designed as a toothing with teeth and teeth intermediate spaces which alternate in a consecutive manner in the circumferential direction of the brake rotation axis. In this case, the two toothings positively mesh into one another in the blocking position of the braking device, so that a positive fit which supports the two braking structures on one another sets in in the circumferential direction of the brake rotation axis. For maintaining the release position, the braking structures which are designed as toothings are distanced to one another to such an extent that the mentioned positive fit is lifted and the two toothings can rotationally move past and on one another.

The design of the toothings is basically arbitrary. For example, the teeth can be designed as pimple-like prominences and the teeth intermediate spaces as individual holes. However, a design to the extent that the teeth each have a profiling which tapers towards their tooth tip and that the tooth intermediate spaces which lie therebetween each have a profiling which tapers towards the tooth intermediate space bottom is particularly advantageous. Toothings which are designed in such a manner can be brought into meshing and out of meshing with one another in a particularly low-wearing manner, but despite this ensure a stable support in the blocking position.

The toothings can each lie in a plane which is at right angles to the brake rotation axis. For example, the toothings can hereby be formed on the assigned braking body axially at the face side similarly to so-called crown gearwheels.

A design of the toothings as cone toothings which are set obliquely with respect to the brake rotation axis is particularly useful. Herein, the cone angles of the toothings of both braking structures open towards the same axial direction. Preferably, the cone angles of the two cone toothings are identical, so that a large-surfaced overlapping between the toothings on both sides is present in the blocking position.

The actuation device of the braking device usefully has a spring device, by way of which the two braking bodies are constantly biased with a spring force in the direction of a braking engagement which defines the blocking position. If it is exclusively the second braking element which is designed for executing the switch-over movement, then the spring device acts between the second braking element and the drive housing. Basically, the spring action can also be reversed, so that it acts in the direction of the release position.

In particular, the spring device is a mechanical spring device, but in principle can also be designed as an air spring device. Given a design as a mechanical spring device, a realisation by way of a multitude of individual spring units which are arranged in a regular distribution distributed annularly around the brake rotation axis is recommended. These spring units in particular are helical compression springs. The spring device can alternatively also be advantageously realised by way of one or more disc springs.

However, at all events it is advantageous if the spring device is a compression spring device.

In combination with the spring device, the actuation device comprises a stroke travel drive device which can be actuated in a controlled manner and by way of which the spring force of the spring device can be overcome, in order to disengage the braking structures from one another when required and in order to maintain the release position which results from this, for as long as is desired. By way of such a design, a safety aspect can be simply realised to the extent that given an energy failure, the braking device is abruptly switched over into the blocking position by way of the spring device.

The actuation device can basically also be constructed without a spring device and comprise exclusively a stroke travel drive device, in order to generate the switch-over movement.

The stroke travel drive device is preferably of a type which can be actuated by way of a fluid force. In particular, it is a pneumatic stroke travel drive device which in particular operates according to the principle of a pneumatic operating cylinder. The stroke travel drive device in this case has a drive piston which with regard to drive is coupled to the braking body to be moved for executing the switch-over movement and which in particular is linearly movable in the axis direction of the brake rotation axis. The drive piston delimits a drive space which communicates with a control channel, through which the drive space can be selectively subjected to an actuation fluid, in particular compressed air, or vented. In this manner, a fluid force which moves the drive piston and hence the braking body which is coupled in movement thereto, into the release position counter to the spring force of the spring device, can be selectively produced, or however a pressure relief of the drive space is possible, said pressure relief permitting the drive piston and hence the braking body which is coupled thereto to move back due to the spring force of the spring device.

Preferably, an electrically actuatable control valve device, by way of which the fluid subjection of the drive space can be controlled according to requirements, is connected onto the control channel. The control valve device is preferably attached to the rotary drive, but can also be placed separately from this and be connected to the control channel via a fluid conduit.

An actuation device which on the one hand comprises a spring device active in the blocking sense and on the other hand is provided with braking structures which are designed as toothings is particularly advantageous. In this case, the two toothings in particular are designed matching one another such that given a switch-over of the braking device from the release position into the blocking position, effected during the rotary output movement, an alternating stroke movement of the second braking body which causes a braking moment takes place, said stroke movement resulting from the two toothings sliding on one another without the stroke travel drive device being actively actuated in any manner. The procedure which therein takes place is comparable to a ratchet. Herein, it is advantageous for the movement energy to firstly be converted into potential energy of the spring device when the two toothings are pressed apart and, given the subsequent renewed moving together of the two toothings, for this energy to be converted into movement energy and finally led away into the drive housing and/or converted into heat. An additional braking effect which however has less of an impact results from the friction of the toothings which slide on one another given the alternating stroke movement. With such a design, a rotating output unit can also be braked up to standstill within the shortest time, even given a high speed. This effect can be utilised during the normal operation of the rotary drive device as well as also in an emergency case for carrying out an emergency braking.

Given a design of the braking device as a ratchet brake in the context explained above, the braking force is a multiple greater than in the case of a braking device which operates in a manner based purely on friction.

By way of the design of the toothings as cone toothings, amongst other things there is a particularly high stability of the teeth. The teeth become higher in the axial direction of the brake rotation axis if one considers them in cross section. In the context of the ratchet braking function, the cone-like or conical design of the toothings has the advantage that the axial linear travel of the created alternating stroke movement is particularly large, from which a particularly high braking performance results.

Usefully, the second braking body of the braking device is designed in an annular manner and is arranged coaxially to the brake rotation axis. The second braking structure is herein in particular located in the region of the radial inner periphery of the second braking body. The first braking body which is provided with the first braking structure is usefully coaxially encompassed by the annular second braking body.

The first braking body is also preferably designed in an annular manner and is arranged coaxially to the brake rotation axis. Herein, it is preferably arranged in the region of the radial outer periphery of an output section of the output unit which is designed for the force take-off. Hereby, the first braking body is preferably designed as one piece with the output section.

As already mentioned further above, it is considered to be useful to design the braking device such that the relative switch-over movement is only executed by the second braking body. The second braking body is hereby movable relative to the drive housing in the axis direction of the brake rotation axis. The first braking body which comprises the first braking structure in contrast is stationarily fixed with respect to the drive housing in the direction of the switch-over movement, which in particular is realised by way of it being arranged on the output section which for its part is mounted on the drive housing in an axially non-movable and only rotatable manner.

The second braking body is usefully mounted on the drive housing in a purely linearly displaceable manner in the axis direction of the brake rotation axis for executing the switch over movement. In order to obtain the desired rotation lock, usefully projections and deepenings which axially mesh into one another in slidingly displaceable manner are formed on the one hand on the second braking body and on the other hand on the drive housing and specifically annularly around the brake rotation axis in a preferably regular distribution.

A robot arm according to the invention is usefully a constituent of a robot and is provided with a sufficient number of arm joints which each connect two arm members of the robot arm to one another in a pivotable manner Each arm joint is formed by at least one rotary drive device of the type mentioned above in various designs, so that the arm members which are articulated on one another are pivotable relative to one another and with regard to angle are positionable relative to one another, in an application specific manner.

As a rule, an end effector, for example a gripping device which is actuated electrically or by way of fluid force and which is positionable by way of the movement of the robot arm is seated at the free end of the robot arm.

### BRIEF DESCRIPTION OF THE DRAWINGS

The invention is hereinafter explained in more detail by way of the accompanying drawing. In these are shown in:

FIG. 1 a preferred embodiment of the rotary drive device according to the invention, in an axial rear view with a viewing direction according to arrow I of FIG. 2,

FIG. 2 the rotary drive device of FIG. 1 in a longitudinal section according to section like II-II of FIG. 1 and as a constituent of a robot arm according to the invention, of which the end sections of two arm members which are fastened to the rotary drive device are indicated in a dot-dashed manner, wherein the braking device is shown in the operating state of the blocking position,

FIG. 3 a cross section of the rotary drive device according to section line of FIG. 2,

FIG. 4 a further a cross section of the rotary drive device according to section line IV-IV of FIG. 2,

FIG. 5 an out-of-centre longitudinal section of the rotary drive device according to the section line V-V of FIGS. 1 and 2, in the blocking position of the braking device,

FIG. 6 a further longitudinal section of the rotary drive device according to section line II-II of FIG. 1, in the operating state of the release position of the braking device, wherein a detail in the region of the two braking structures and which is framed in a dot-dashed manner is represented separately once again in an enlarged manner,

FIG. 7 a cross section of the rotary drive device according to section line VII-VII of FIG. 6, and

FIG. 8 a further out-of-centre longitudinal section of the rotary drive device in the release position of the braking device according to section line VIII-VIII of FIG. 6.

### DETAILED DESCRIPTION

FIG. 2 shows a detail of a robot arm of a robot which is denoted in its entirely with the reference numeral 1. The robot arm 1 has several arm members 2a, 2b which are merely indicated by a dot-dash and which as a rule are always connected to one another in pairs in a manner in which they are pivotable to one another, by way of an arm joint 3 of the robot arm 1. The arm joint 3 is formed by a rotary drive device 4 which in the other figures of the drawings is represented without the arm members 2a, 2b.

The use of the rotary drive device 4 as an arm joint 3 in a robot arm 1 is particularly advantageous, but does not represent the only possibility of use of the rotary drive device 4. The same can be used for arbitrary many applications, with regard to which it is a case of rotating two components relative to one another and/or positioning them with regard to rotation angle. For example, the rotary drive device 4 can be used for rotating and/or the positioning with respect to the rotation angle, of two machine parts of a production facility or of a packaging machine. These examples are not to be understood as conclusive.

The rotary drive device 4 comprises a rotary drive 5, concerning which it is the case for example of a fluid-actuated rotary drive 5. It is operated amid the use of a drive fluid which is under pressure and which can be fluid or gaseous and concerning which it is preferably the case of compressed air. The description of the preferred embodiment example is effected on the basis of a pneumatic rotary drive 5 which can be operated with compressed air.

According to embodiment examples which have not been illustrated, the rotary drive 5 can also be an electrical rotary drive or a rotary drive 5 which is operated in combined manner electrically and by way of a fluid force. An electrical rotary drive as a drive source preferably comprises an electric motor, concerning which in particular it is an electrical servomotor or a stepper motor. The further embodiments accordingly apply to such rotary drives 5.

The rotary drive 5 has an output unit 7 which can be driven into a rotary output movement 6 which is indicated by a double arrow. The output unit 7 has a longitudinal axis 8 which defines a rotation axis 8a for the rotary output movement 6.

The rotary drive 5 has a housing which is denoted as a drive housing 12, with respect to which the output unit 7 is rotatable for executing its rotary output movement 6. The output movement 6 can be produced amid the interaction of drive components 13 of the rotary drive 5 which are located in the inside of the drive housing 12. By way of example, the output unit 7 can be rotationally driven in a bi-directional manner, thus in two opposite rotation directions, by way of the drive components 13. In this manner, the output unit 7 can be positioned in a very exact manner with regard to the rotation angle.

By way of example, the maximal rotation angle of output unit is limited to below 360 degrees. It lies for example at 270 degrees. This has to do with the design principle of the exemplary rotary drive 5 which is yet to be explained.

Basically, the rotary drive 5 can also be designed for a unidirectional output movement 6 of the drive unit 7 which is not limited with regard to the rotation angle.

The rotary drive device 4 additionally to the rotary drive 5 comprises a braking device 14 which is designed in a manner such that in a releasable manner it permits a non-rotatable blocking of the output unit 7 with respect to the drive housing 12, wherein the blocking measure relates to both possible rotation directions. The output unit which is non-rotatably blocked by the braking device 14 is therefore neither rotatable in the clockwise direction nor in the anti-clockwise direction. The operating state which is assumed by the braking device 14 is herein denoted as a blocking position.

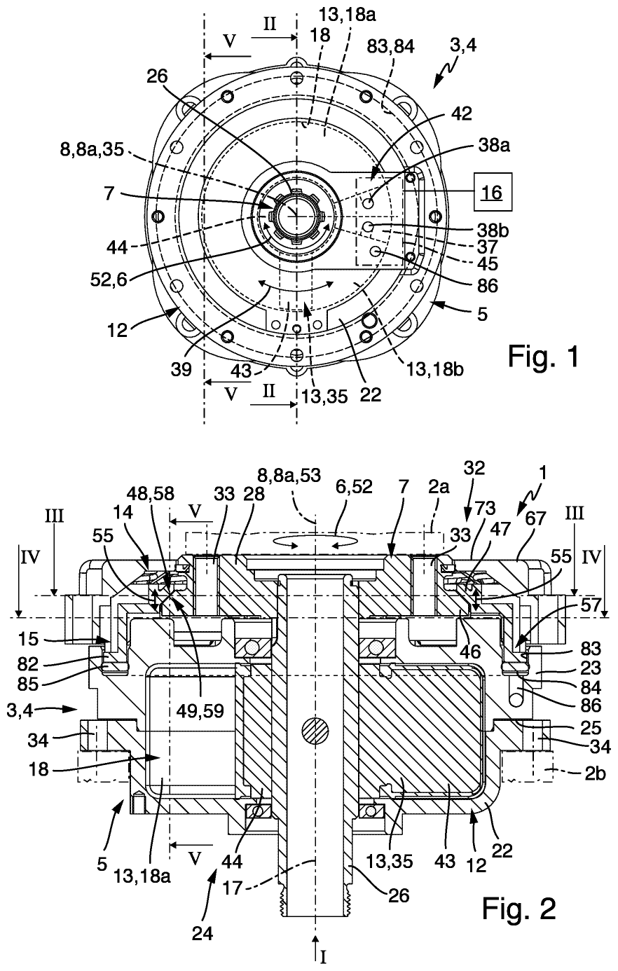

The braking device 14 has an actuation device 15, by way of which the operating state of the braking device 14 when required can be switched between the aforementioned blocking position and a release position which permits the output unit 7 an unhindered execution of the rotary output movement 6. The set operating state can furthermore be temporarily fixed by way of the actuation device 15. The actuation device 15 in particular is designed such that an arbitrary time duration of the assumption of the blocking position and of the release position of the braking device can be set by it. Furthermore, the blocking position can be created in different rotation positions of the output unit 7. A non-rotatable blocking is not only possible in the two rotation-angle-related end positions of the output unit 7, but also in a multitude of rotation intermediate positions which lie therebetween, in particular in a stepless or finely graded manner. For this, the actuation device 15 is accordingly activatable with regard to operation. Preferably, the rotary drive device 4 is provided with an electronic control device 16 which is only illustrated schematically in FIG. 1 and by way of which the actuation device 15 can be electrically activated for setting the operating state of the braking device 14.

The rotary drive 5 has a longitudinal axis 17, with which the longitudinal axis 8 of the output unit 7 usefully coincides.

A housing interior 18 is formed in the inside of the drive housing 12. The longitudinal axis 17 forms the centre of this housing interior 18, said interior usefully being designed in a circularly cylindrical manner and is arranged coaxially to the longitudinal axis 17.

The housing interior 18 by way of example is delimited by two first and second housing parts 22, 23 which are applied onto one another in the axis direction of the longitudinal axis 17. The first housing part 22 is assigned to an axial rear side 24 of the rotary drive 5. Preferably, the two housing parts 22, 23 are designed in a beaker-like manner so that they each axially and peripherally delimit a recess, wherein they are applied onto one another in a sealed manner in a joining plane 25 with openings of these recesses which face one another. By way of this, the two recesses complement one another into the housing interior 18. The two housing parts 22, 23 are fastened to one another for example by way of a screw connection.

The output unit 7 has an output shaft 26 which extends coaxially through the drive housing 12 and herein also through the housing interior 18. The output shaft 26 is rotatable relative to the drive housing 12 about the rotation axis 8a, wherein a bearing device 27 which is only indicated in a schematic manner and which in particular is a roller bearing device is provided on the two housing parts 22, 23 for the rotational mounting.

The output unit 7 has an output section 28 which is accessible from outside the drive housing 12. The output section 28 by way of example is located in the region of an axial front side 32 of the rotary drive 5 which is opposite to the axial rear side 24. The output section 28 can be formed in a direct manner by an end section of the output shaft 26, but preferably consists of a disc-like body which in a coaxial alignment is fastened in a rotationally fixed manner to an end section of the output shaft 26 which projects out of the drive housing 12 in a region of the front side 32. This is the case in the illustrated embodiment example.

At least one fastening interface 33 which can be used for a force take-off and which is denoted as the first fastening interface 33 for an improved differentiation is formed on the output section 28. A component which is to be moved in a rotary manner can be fastened to it. By way of example, the one, first arm member 2a of the two arm members 2a, 2b is fastened to the first fastening interface 33. The first fastening interface 33 consists for example of one or more fastening holes.

At least one second fastening interface 34 is preferably formed on the drive housing 12 and is suitable for fastening a further component, with respect to which the component which is attached to the first fastening interface 33 is to be rotated. By way of example, the second arm member 2b of the two arm members 2a, 2b is fastened to the second fastening interface 34. The second fastening interface 34 usefully consists of one or more fastening holes.

With regard to the drive component 13 which is mentioned further above, it is the case of a pivoting piston 35. The pivoting position 35 is located in the housing interior 18 where it is connected to the output shaft 26 in a rotationally fixed manner. It is stuck for example onto the output shaft 26 and by way of a transverse bolt 36 which also passes through the output shaft 26 is fixed to the output shaft 26 such that a torque transmission is possible. Alternatively, the pivoting piston 35 could also be stuck for example also with an inner toothings onto an outer toothing of the output shaft 26.

Together with a separating wall element 37 which is inserted into the housing interior 18 in a stationary manner, the pivoting piston 35 divides the housing interior 18 into two drive chambers 18a, 18 which are hereinafter denoted as the first and the second drive chambers 18a, 18b and likewise belong to the drive components 13. One of two first and second drive channels 38a, 38b which pass through the drive housing 2 runs out into each of the drive chambers 18a, 18b, and these drive channels at the other side run out in a connection region 42 on the outer surface of the drive housing 12.

A controlled fluid impingement of the two drive chambers 18a, 18b and thus of the pivoting piston 35 with a drive fluid is possible through the two drive channels 38a, 38b, in order to cause a rotary output movement 36 of the output unit 7. The rotation direction is defined by the pressure difference which exists between the two drive chambers 18a, 18b. The output unit 7 can be non-rotatably fixed in any arbitrary rotation position relative to the drive housing 12 by way of setting an equally high pressure. The rotary output movement can be taken off at the output section 28.

For generating the torque which causes the output movement 6, the pivoting piston 35 has a wing section 43 which projects radially with respect to the longitudinal axis 8 and which amid sealing in a slidingly movable manner bears on the wall surface of the drive housing 12 which delimits the housing interior 18. The pivoting piston 35 moreover has a bush section 44 which extends around the output shaft 26 and which likewise bears on the wall surface of the housing interior 18 and also on the separating wall element 27 in a slidingly displaceable manner amid sealing. Each drive chamber 18a, 18b therefore has an arcuate extension between the separating wall element 37 and the wing section 43, wherein the arc length changes given the pivoting movement 39 of the pivoting piston 35 which creates the output movement 6.

The separating wall element 37 by way of interacting with the wing section 43 can function as a stop element which defines a maximal pivot angle of the pivoting piston 35. This maximal pivoting angle is smaller than 360 degrees and is for example 270 degrees. The maximal pivot angle corresponds to the maximal rotation angle of the rotary output movement 6 between two end rotation positions.

For the controlled fluid subjection of the two drive chambers 18a, 18b, the rotary drive device 4 is usefully provided with an electrically actuatable control valve device 45 which by way of example is fastened to the connection region 42 of the drive housing 12 such that it commutates with the drive channels 38a, 38b which run out there. The control valve device 35 for its part is connectable or connected to the electronic control device 16, from which it obtains electrical control signals which determine its operating state. The control valve device 45 is connected in a manner which is not illustrated any further, onto a pressure source which provides the drive fluid, and also to a pressure sink, in particular to the atmosphere.

The braking device 14 has a first braking body 46 which is provided with a first braking structure 48. It moreover has a second braking body 47 which is separate with respect to the first braking body 46 and which is provided with a second braking structure 49.

The first braking body 46 with regard to the drive is coupled to the output unit 7 in a manner such that it takes part in its output movement 6 and constantly executes a corresponding rotation movement 52 which for a better differentiation is denoted as a brake rotation movement 52. A coupling which transmits torque in both possible rotation directions is present between the first braking body 46 and the output unit 7.

The brake rotation movement 52 takes place with respect to a rotation axis which is denoted as a brake rotation axis 53 for an improved differentiation. The same does not necessarily need to have the same alignment as the rotation axis 8 of the output unit 7 if a suitable deflection gear is arranged therebetween. Preferably however, the brake rotation axis 53 and the rotation axis 8a of the output unit 7 have the same alignment amongst one another, wherein it is seen as being particularly advantageous if these rotation axes 53, 8a are arranged coaxially to one another and thus practically coincide.

The first braking structure 48 which is arranged on the first braking body 46 always directly takes part in the brake rotation movement 52.

The second braking body 47 which comprises the second braking structure 49 is arranged in a non-rotatable manner with respect to the drive housing 12. Expressed differently, the second braking body 47 is rotationally secured with respect to the drive housing 12. A rotation lock device 54 which is preferably present in this context will be dealt with further below.

The two braking structures 48, 49 are formed on the braking bodies 46, 47 in a manner such that they lie opposite one another in the axis direction of the brake rotation axis 53 and face one another. This exemplarily means that the two braking structures 48, 49 face one another in the axis direction of the longitudinal axis of the output unit 7.

A switch-over movement 55 which is indicated in the drawing by a double arrow can be created by way of the actuation device 15, said switch-over movement being a relative movement between the two braking bodies 46, 47 and thus therefore between the two braking structures 48, 49 which are formed thereon. The operating state of the braking device 14 can be switched between the release position and the blocking position by way of the switch-over movement 55. The blocking position results from the two braking structures 48, 49 being in a braking engagement with one another, by way of which the two braking bodies 46, 47 are not rotatable relative to one another with respect to the braking rotation axis 53, and specifically with respect to both possible rotation directions. The release position results from the two braking structures 48, 49 being disengaged from the braking engagement with one another, thus the braking engagement which is present in the blocking position being lifted, so that the two braking bodies 46, 47 are rotatable to and fro relative to one another with respect to the brake rotation axis 53 in a non-braked manner.

Since the first braking body 46 is coupled in movement to the output unit 7 and the second braking body 47 is arranged on the drive housing 12 in a non-rotatable manner, a non-rotatable blocking of the output unit 7 with respect to the drive housing 12 or a release between the two aforementioned constituents 7, 12 which permits the rotary output movement 6 can be created by way of the actuation device 15.

Basically, it is of no significance as to which of the two braking bodies 46, 47 moves given a switch-over movement 55. Basically, even both braking bodies 46, 47 can participate in the relative switch-over movement 55. The design which is realised with the illustrated embodiment example and with regard to which it is exclusively the second braking body 47 which executes and which can execute the switch-over movement 55, whereas the first braking body 46 is fixed in a stationary manner with respect to the drive housing 12 in the direction of the switch-over movement 55 is seen as being particularly useful.

The fixation of the first braking body 46 which with respect to the drive housing 12 is stationary in the direction of the switch-over movement 55, by way of example results from the first braking body 46 being fixedly arranged on the output unit 7 which for its part is immovable with respect to the drive housing 12 in the axis direction of the longitudinal axis 8. This aforementioned axial immovability in particular is effected by way of the bearing device 27.

The direct arrangement of the first braking body 46 on the output unit 7, realised with this embodiment example, permits compact dimensions of the rotary drive device 4 and avoids a coupling between the output unit 7 and the first braking body 46, which is burdened by play and possibly has an effect on the precision.

Usefully, the first braking body 46 is fixedly attached to the output section 28 of the output unit 7. By way of this, the braking action is concentrated onto a region which is located in the direct vicinity of the at least one first fastening interface 33.

By way of example, the first braking body 46 is designed in an annular manner and is arranged on the radially outwardly lying edge region of the output section 28 in an alignment which is coaxial to the longitudinal axis 8. Concerning the first braking body 46, it can be the case of an annular body which is separate with regard to the output section 28 and which is fastened to the output section 28 in an arbitrary manner by way of suitable fastening measures. However, the illustrated design, concerning which the annular first braking body 46 is designed as one piece with the output section 28 is seen as being particularly advantageous. By way of this, high braking torques can be transmitted between the first braking body 46 and the output unit 7.

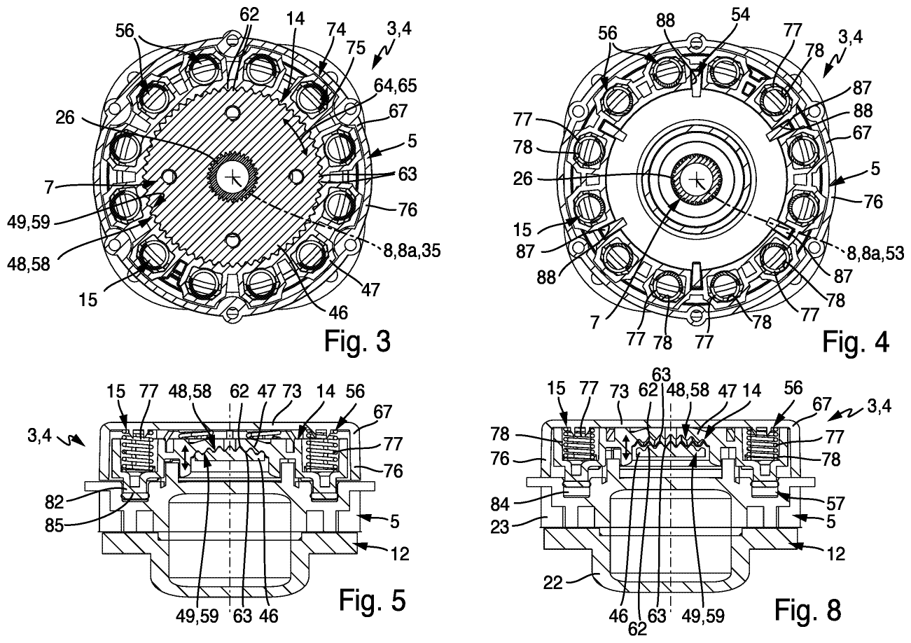

The first braking structure 48 which is arranged on the first braking body 46 is preferably designed in an annulus-shaped manner and is arranged coaxially to the brake rotation axis 53 which by way of example results in a coaxiality with the longitudinal axis 8 of the output unit 7 being present. Accordingly, the first braking structure 48 has a longitudinal extension which is curved in a circular-arc-shaped manner with a centre of curvature which lies on the brake rotation axis 53. This design can easily be recognised in the FIGS. 3 and 7.

The second braking body 47 is usefully likewise designed in an annular manner and is arranged coaxially to the brake rotation axis 52. By way of example, the disc-shaped output section 28 is encompassed radially to the outside a concentric manner by the annular second braking body 47. The second braking structure 49 is located in the region of the radial inner periphery of the annular second braking body 47.

The second braking structure 49 which is formed on the second braking body 47 is preferably designed in an annulus-shaped manner and is arranged coaxially to the brake rotation axis 53. Accordingly, the second braking structure 49 has a longitudinal extension which is evident from the FIGS. 3 and 7 and which is curved in a circular-arc-shaped manner with a curvature centre which lies on the brake rotation axis 53.

The two braking structures 48, 49 which are coaxial to one another lie opposite one another in the axis direction of the brake rotation axis 53 in a manner such that they overlap in direction which is radial with respect to the brake rotation axis 53.

In particular, in cases in which the maximal rotation angle of the rotary output movement 6 is relatively small, the longitudinal extension of the first braking structure 48 and/or of the second braking structure 49 can also be less than 360 degrees, which differs from the illustrated embodiment example.

In the blocking position, the first braking body 46 bears with its first braking structure 48 on the second braking structure 49 of the second braking body 47. An adequately high pressing force can be provided by the actuation device 15, in order to hold the two braking structures 48, 49 in a mutual braking engagement in a manner in which they are not rotatable relative to one another. The necessary braking force by way of example is provided by a spring device 56. The spring force which functions as a braking force preferably prevails constantly.

The actuation device 15 is designed in a manner which permits the operating state of the braking device 14, when required whilst overcoming of the spring force of the spring device 56 which functions as a braking force, to be switched into the release position and to maintain the operating state of the release position as long as is desired. For this purpose, the actuation device 15 is preferably provided with a stroke travel drive device 57 which can be activated when required. With its help, the two braking structures 48, 49 which are constantly pressing on one another due to the spring device 56 can be brought out of engagement with one another, so that the braking device 14 no longer exerts a braking moment upon the output unit 7.

According to an embodiment example which is not illustrated, the two braking structures 48, 49 are designed such that the braking effect which is present in the blocking position is based exclusively or at least essentially exclusively on a friction force. The braking structures 48, 49 in this case in particular are designed as plane braking surfaces. In this case, brake pads which consist of a material with a higher coefficient of friction and at the same time a high temperature resistance are preferred. Braking structures 48, 49 which are designed in such a manner provide the advantage of a stepless, non-rotatable blocking in every rotation angle position which is assumed between the two braking bodies 46, 47.

On account of a particularly high braking effect, an embodiment concerning which each of the two braking structures 48, 49 is designed as a toothing is preferred, wherein concerning the toothing of the first braking structure 48 one speaks of a first toothing 58 and concerning the toothing of the second braking structure 49 one speaks of a second toothing 49, for an improved differentiation.

The two toothings 58, 59 are matched to one another such that during the blocking position they are in a positive engagement with one another and during the release position they are distanced to one another such that a positive engagement is no longer present. The positive-fit action relates to the rotation direction of the rotary output movement 6.

As one can derive in particular from the FIGS. 5 and 8, each toothing 58, 59 consists of a succession of teeth 62 and teeth intermediate spaces 63 which alternate in the circumferential direction 64 of the brake rotation axis 53. The circumferential direction 64 of the brake rotation axis 53 which is illustrated by a double arrow is the direction annularly around the brake rotation axis 53 and simultaneously defines an arcuate longitudinal direction 65 of the two braking structures 48, 49.

Preferably, each tooth 62 and each tooth intermediate space 63 has a longitudinal extension which is orientated at right angles to the longitudinal direction 65 of the assigned toothing 58, 59.

Furthermore, each tooth 62 usefully comprises a profiling which tapers towards its tooth tip, wherein each tooth intermediate space 63 has a profiling which tapers towards the intermediate space bottom. The profilings of the teeth 62 and of the teeth intermediate spaces 63 are usefully identical amongst one another. The tooth tips are preferably rounded just as the intermediate space bottoms. In particular, this design is quite evident from the FIGS. 3, 5, 7, and 8.

In the blocking position of the braking device 14, the teeth 62 of the one toothing 58, 59 immerse into the tooth intermediate spaces 63 of the respective other toothing 59, 58, so that a positive mutual supporting of the two toothings 58, 59 sets in in the longitudinal direction 65 in the clockwise direction as well as in the anti-clockwise direction.

According to a non-illustrated embodiment example, the two braking structures 48, 49 extend in a plane which is at right angles to the brake rotation axis 53. Herein, all tooth tips which belong to the same toothing 58, 59 lie in one and the same plane. Braking structures 48, 49 which are designed as brake surfaces which can be applied onto one another in a flat manner each have an annulus-shaped design. Braking structures 48, 49 which are designed as toothings 58, 59 in this case in particular are realised in the manner of so-called crown toothings.

However, it is seen as being particularly advantageous if the braking structures 48, 49 each lie on a cone lateral surface. For reasons which are yet to be explained, this is above all advantageous given a design as toothings 58, 59. Accordingly, the two toothings 58, 59 of the embodiment example are designed as cone toothings which are set obliquely with respect to the brake rotation axis 53. The conical first toothing 58 is hereby an outer toothing of the first braking body 46, whereas the conical second toothing 59 is designed as an inner toothing of the annular second braking body 47. The cone angle with the two toothings 58, 59 is preferably 90 degrees. In other words, each toothing 58, 59 has an obliqueness of 45 degrees with respect to the brake rotation axis 53.

The axial direction component of the first braking structure 48 preferably points in the direction of the axial front side 32 of the rotary drive 5. The second braking structure 49 is orientated opposite in the direction of the axial rear side 24.

Usefully, the second braking body 47 is arranged in a braking chamber 66 of the drive housing 12 which is arranged axially at a distance in front of the housing interior 18. The braking chamber 66 by way of example is commonly delimited by the second housing part 23 and by a third housing part 67 of the drive housing 12 which is applied thereon at the side which faces the front side 32.

Preferably, the output section 28 at least with the greater part of its axial height is arranged in the braking chamber 66.

The third housing part 67 has a central wall opening 68 in the region of the axial front side 32, through which opening the output section 28 with its at least one first fastening interface 33 is accessible from the outside. The output section 28 usefully projects axially into the central wall opening 68. Usefully, an annular seal 72 is integrated between the output section 28 and the edge region of the third housing part 67 which frames the central wall opening 68, so that the braking chamber 66 is shielded towards the surroundings and no contamination can penetrate.

The third housing part 67 is fastened to the second housing part 23 by way of a screw connection or in another manner.

The third housing part 6 has an annular terminating wall 73 which lies axially opposite the second housing part 23 at a distance. The spring device 56 is arranged between the second braking body 47 and this terminating wall 73, wherein it is supported on these two aforementioned components 47, 73. The spring device 56 is preferably designed as a compression spring device, so that it constantly impinges the second braking body 47 in the direction of the second braking structure 49 in a spring-elastic manner.

The switch-over movement 55 is preferably a purely linear movement. Usefully therefore, the second braking body 47 is mounted in the drive housing 12 in a linearly displaceable manner with respect to this. In this context, one can easily recognise in FIGS. 3 and 4 that the second braking body 47 on its radial outer periphery comprises an outer guide surface 74 which is coaxial to the brake rotation axis 53 and which bears on a complementarily inner guide surface 75 in a slidingly displaceable manner, said inner guide surface being formed by an inner wall surface of the third housing part 67 which delimits the braking chamber 66. By way of example, the outer guide surface 74 is segmented in the circumferential direction 64 of the brake rotation axis 53, but it can also be designed as a continuous cylindrical surface. The inner guide surface 75 is usefully located at the inside on a peripheral side wall 76 of the third housing part 67 which radially delimits the braking chamber 66 to the outside and with which the third housing part 67 is axially supported on the second housing part 23.

The spring device 56 is preferably composed of a multitude of compression spring units 77 which are arranged distributed annularly around the brake rotation axis 53 in the braking chamber 66. It is preferably the case of a regular distribution.

Usefully, a number of receiving pockets 78, in which one of the compression spring units 77 is received is formed in the second braking body 47, wherein this number corresponds to the number of compression spring units 77. The receiving pockets 78 are designed in the manner of blind holes and are open at the side which faces the terminating wall 23. Hence each compression spring unit 77 on the one hand can be supported on the base surface of its receiving pocket 78 and on the other hand on the axial inner surface of the terminating wall 73.

The compression spring units 77 are preferably designed as helical springs.

Alternatively, they could also be realised for example as disc spring assemblies. Instead of a plurality of compression spring units 77, the spring device 56 could basically also be realised with only a single compression spring which is dimensioned in an accordingly larger manner.

The switch-over movement 55 of the second braking body 47 as well as the maintenance of the blocking position and of the release position for a desired time duration can be created with the help of the stroke travel drive device 57 of the actuation device 15.

With regard to an embodiment example which is not illustrated, the stroke drive device 57 is an electrical stroke travel drive device. For example; it can have an electromotoric or electromagnetic drive unit. However, it is seen as being more advantageous if the stroke travel drive device 57 is of a type which can be actuated by way of a fluid force, which is the case with the illustrated embodiment example. By way of example, compressed air is applied as an actuation fluid, so that here it is the case of a pneumatic stroke travel drive device 57.

The linear travel drive device 57 comprises a drive piston 82 which with regard to drive is coupled to the second braking body 47 for the control of the switch-over movement 55. The drive piston 82 is seated at least partly in a piston chamber 83 which is formed in the drive housing 12, connects onto the braking chamber 66 at the side which faces the rear side 24 and is open to the braking chamber 66. The piston chamber 83 is preferably formed in the second housing part 23 in the manner of a blind hole.

The drive piston 82 delimits a drive space 84 which lies on the side of the drive piston 82 which is away from the braking chamber 66, and specifically amid sealing, for which purpose a suitable seal 85 is assigned to the drive piston 82 in the piston chamber 83. The seal 85 is usefully received in the piston chamber 83 in a slidingly movable manner.

By way of example, the drive piston 82 is fixedly connected to the second braking body 47, so that these two constituents form a construction unit which is only movable as a unit.

As an alternative to the illustrated embodiment example, the drive piston 82 can also be designed separately from the second braking body 47. It is then arranged in front of the second braking body 47 axially towards the rear side 24 in a manner such that given a pressure impingement of the drive space 84, it can exert a pushing force upon the second braking body 47.

The seal 85 can be fixedly attached on the drive piston 82. However, it can also be loosely arranged in the drive space 84 and be arranged axially in front of the drive piston 82.

The drive space 84 is in fluid connection with a control channel 86 which passes through the drive housing 12 and which usefully leads to the connection region 42 where it is connected onto the already described control valve device 45. The latter is usefully composed of several control valves units which can be actuated independently of one another and of which at least one serves for activating the rotary drive 4 and at least one serves for the activation of the linear displacement drive device 57.

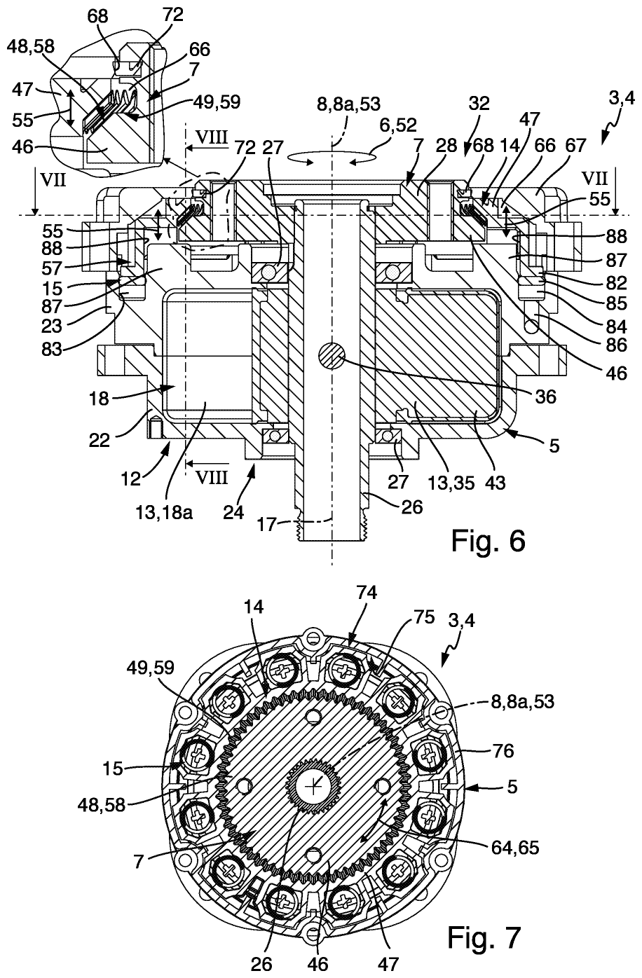

The drive space 84 can be selectively subjected to an actuation fluid or relieved in pressure by way of the control valve device 45 which is commanded by the electronic control device 16. In the state subjected to pressure, a pressure force acts upon the drive piston 82, said pressure force being greater than the spring force of the spring device 56 which acts opposite to this. For this reason, the drive piston 82 pushes the second braking body 47 out of braking engagement with the first braking body 46 into the release position which is evident from FIGS. 6 to 8. The release position is maintained as long as the actuation fluid prevails in the drive space 84.

In order to switch back into the blocking position, it is sufficient to relieve the drive space 84 with regard to pressure, thus by way of example to vent it, by way of a suitable actuation of the control valve device 45. On account of the fluidic pressure force which is then no longer present, the second braking body 47 is pushed back into the blocking position by way of the spring force of the spring device 56. This is maintained until the drive space 84 is again subjected to overpressure by way of the control valve device 45.

It is particularly advantageous for the operating state of the braking device 15 to not only be actuatable in the two end rotation positions of the output unit 7, but also in a multitude of intermediate rotation positions which lie between the two end rotation positions. Practically every relative pivoting position which is assumed between the arm members 2a, 2b can be releasably blocked by way of this.

It is further advantageous if the operating state of the braking device 14 can be switched from the release position into the blocking position during the rotary output movement 6. By way of this, the rotary drive device 4 can be operated with a practically high dynamics. Furthermore when necessary, emergency braking can be activated, such during the operation of the rotary drive device 4 being able to create a rapid as possible stoppage of the output movement 6.

In this context, particularly advantages result from the design of the two braking structures 48, 49 as toothings 58, 59. If the braking device 14 is switched over from the release position into the blocking position by way of venting the drive space 84 during a rotary output movement 6 of the output unit 7, then this leads to the second toothing 59 engaging with the first toothing 58. If no particularly high torque is present at the output unit 7, then this can result in an abrupt stoppage of the output movement 6. If the prevailing torque however is relatively high, for example due to a high rotation speed and/or to a very large moved mass, then the inclined flanks of the teeth 62 and the teeth intermediate spaces 63 effect an axial ratchet function, during which the rotation of the output unit 7 is gradually brought to a standstill. The ratchet function manifests itself by way of the two toothings 58, 59 sliding on one another given a rotating output unit 7, wherein the second toothing 69 and thus the complete second braking body 47 is driven into an alternating stroke movement in the direction of the switch-over movement 55. On account of the energy for compressing the spring device 56 which is thereby to be periodically mustered, a braking moment which is opposed to the rotation direction of the output movement 6 and by way of which the output unit 7 is braked within the shortest time to a standstill and until reaching the stable blocking position arises.

The usefully realised cone-shaped design of the two toothings 58, 59 on the one hand has the advantage that the teeth 82 are particularly stable. Furthermore, by way of this a greater axial [linear] travel of the second braking body 47 is required for carrying out the ratchet function, so that the spring device 56 must be compressed to a greater extent, from which an even high braking power results.

According to the illustrated embodiment example, it is advantageous if the piston chamber 83 is designed in an annular manner and is arranged coaxially to the brake rotation axis 53. In this case, the drive position 82 is designed as an annular piston which is designed in a complementary manner in cross section and which likewise extends coaxially annularly around the brake rotation axis 53. In this manner, the fluidic drive forces can be introduced into the second braking body 47 in a symmetrical manner with a uniform distribution, so that there is no danger of jamming.

The rotation lock device 54 which has already been mentioned above by way of example consists of a plurality of projections 87 and deepenings 88 which mesh into one another in an axially slidingly displaceable manner By way of example, the projections 87 are formed on the drive housing 12 and the deepenings 88 on the second braking body 47.

The projections 47 and the deepenings 88 are arranged distributed annularly around the brake rotation axis 53. The projections 87 which are designed for example in a plate-like manner, are formed within the braking chamber 66 on the second housing part 22 and project in the direction of the second braking body 47. The latter in the region of its inner circumference has a plurality of the deepenings 88, into which the projections 87 immerse. The projections 87 and deepenings 88 which constantly engage into one another ensure a positive, rotationally fixed fixation of the section braking body 47 with respect to the drive housing 12, wherein they simultaneously permit the switch-over movement 55.

The rotation-lock device 54 alternatively or additionally to the measures which are described further above can be an axial linear guide device for the second braking body 47. 1.

What is claimed is:

1. A rotary drive device, comprising a rotary drive which comprises a drive housing and an output unit which with respect to the drive housing is drivable into a rotary output movement about its longitudinal axis by way of drive components which are arranged in the drive housing, and comprising a device for the non-rotatable blocking of the output unit in different rotation positions, wherein the device for blocking the output unit is a braking device which is provided with an actuation device and whose operating state can be actively switched, by way of the actuation device, between a release position, which permits an unhindered rotation of the output unit, and a blocking position, which blocks the output unit in both directions in a non-rotatable manner, wherein the braking device comprises a first braking body which is provided with a first braking structure and which is drivingly coupled to the output unit and during the output movement of the output unit executes a rotation movement about a brake rotation axis and wherein the braking device comprises a second braking body which is arranged in a non-rotatable manner with respect to the drive housing and which comprises a second braking structure which lies opposite the first braking structure in the axis direction of the brake rotation axis, wherein a relative switch-over movement between the two braking bodies in the axis direction of the brake rotation axis is able to be created by way of the actuation device, said switch-over movement effecting a switch-over of the operating state of the braking device, wherein by way of the switch-over movement the two braking structures can be brought into braking engagement with one another or out of braking engagement for selectively creating the blocking position or the release position.

2. The rotary drive device according to claim 1, wherein the output unit is drivable into a bidirectional rotary output movement between two end rotation positions, wherein the braking device is designed in a manner such that its operating state in both end rotation positions of the output unit as well as in a multitude of intermediate rotation positions of the output unit which lie between the two end rotation positions is able to be switched between the release position and the blocking position.

3. The rotary drive device according to claim 1, wherein the braking device is designed in a manner such that its operating state can be switched from the release position into the blocking position during the rotary output movement of the output unit.

4. The rotary drive device according to claim 1, wherein the output unit comprises an output section which is accessible from the outside of the drive housing and comprises at least one fastening interface which can be used for a force take-off.

5. The rotary drive device according to claim 1, wherein the brake rotation axis is arranged coaxially to the rotation axis of the output unit.

6. The rotary drive device according to claim 5, wherein the first braking body is arranged directly on the output unit.

7. The rotary drive device according to claim 6, wherein the output unit comprises an output section which is accessible from the outside of the drive housing and comprises at least one fastening interface which can be used for a force take-off, wherein the first braking body is arranged on the output section of the output unit.

8. The rotary drive device according to claim 1, wherein the rotary drive is a fluid-actuated rotary drive which as a drive component comprises a pivoting piston which is arranged in a housing interior of the drive housing, is connected to the output unit in a rotationally fixed manner and by way of controlled fluid subjection of two drive chambers, which are compartmentalised from one another by the pivoting piston in the housing interior, is driveable into a pivoting movement which causes the rotary output movement.

9. The rotary drive device according to claim 1, wherein the first braking structure has a circular-arcuately curved longitudinal extension, wherein the centre of curvature lies on the brake rotation axis.

10. The rotary drive device according to claim 1, wherein the first braking structure is designed in an annulus-shaped manner and is arranged coaxially to the brake rotation axis.

11. The rotary drive device according to claim 1, wherein the second braking structure has a circular-arcuately curved longitudinal extension, wherein the centre of curvature lies on the brake rotation axis.

12. The rotary drive device according to claim 1, wherein the second braking structure is designed in an annulus-shaped manner and is arranged coaxially to the brake rotation axis.

13. The rotary drive device according to claim 1, wherein each of the two braking structures is designed as a toothing with teeth and teeth intermediate spaces which are consecutive in an alternating manner in the circumferential direction of the brake rotation axis, wherein the two toothings positively mesh into one another in the blocking position of the braking device and are not in engagement with one another in the release position.

14. The rotary drive device according to claim 13, wherein the teeth of the two toothings each have a profiling which tapers towards the tooth tip, and the tooth intermediate spaces of the two toothings each have a profiling which tapers towards the intermediate space bottom.

15. The rotary drive device according to claim 13, wherein toothings are designed as cone toothings which are set obliquely with respect to the brake rotation axis.

16. The rotary drive device according to claim 1, wherein the actuation device comprises a spring device by way of which the two braking bodies are constantly biased with a spring force in the direction of a braking engagement which defines the blocking position, wherein the actuation device further comprises a stroke travel drive device which can be actuated in a controlled manner and by way of which the spring force of the spring device can be overcome, in order to cause a switch-over movement which brings the braking structures out of engagement with one another.

17. The rotary drive device according to claim 16, wherein the stroke travel drive device is of a type which can be actuated by way of a fluid force and comprises a drive piston which is drivingly coupled to one of the two the braking bodies, is linearly movable in the axis direction of the brake rotation axis and delimits a drive space, said drive space communicating with a control channel and for creating the switch-over movement, through the control channel, being able to be selectively subjected to an actuation fluid or relieved in pressure.

18. The rotary drive device according to claim 16, wherein each of the two braking structures is designed as a toothing with teeth and teeth intermediate spaces which are consecutive in an alternating manner in the circumferential direction of the brake rotation axis, wherein the two toothings positively mesh into one another in the blocking position of the braking device and are not in engagement with one another in the release position, wherein the toothings of the two braking structures are designed matching one another in a manner such that during a switch-over of the braking device from the release position into the blocking position, effected during an output movement, an alternating stroke movement of the second braking body which causes a braking moment can take place up to the standstill of the output movement without an active actuation of the stroke travel drive device, by way of the two toothings sliding on one another.

19. The rotary drive device according to claim 1, wherein the second braking body is designed in an annular manner and is arranged coaxially to the brake rotation axis, wherein the second braking structure is arranged in the region of the radial inner periphery of the second braking body.

20. The rotary drive device according to claim 1, wherein only the second braking body which comprises the second braking structure is designed for executing the switch-over movement, whereas the first braking body which comprises the first braking structure is fixed in a stationary manner with respect to the drive housing in the direction of the switch-over movement.

21. The rotary drive device according to claim 20, wherein the second braking body is mounted on the drive housing in a purely linearly displaceable manner in the axis direction of the brake rotation axis for executing the switch-over movement, wherein for the rotation lock with respect to the drive housing, projections and deepenings which axially mesh into one another in slidingly displaceable manner are formed on the second braking body and on the drive housing distributed annularly around the brake rotation axis.

22. A robot arm of a robot, comprising at least two arm members which by way of an arm joint are connected to one another in a pivotable manner relative to one another, wherein the arm joint is formed by at least one rotary drive device which comprises a drive housing and an output unit which with respect to the drive housing is drivable into a rotary output movement about its longitudinal axis by way of drive components which are arranged in the drive housing, wherein one of the two arm members is connected to the output unit and the other one of the two arm members is connected to the drive housing, wherein the rotary drive device further comprises a device for the non-rotatable blocking of the output unit in different rotation positions, wherein the device for blocking the output unit is a braking device which is provided with an actuation device and whose operating state can be actively switched, by way of the actuation device, between a release position which permits an unhindered rotation of the output unit and a blocking position which blocks the output unit in both directions in a non-rotatable manner, wherein the braking device comprises a first braking body which is provided with a first braking structure and which is drivingly coupled to the output unit and during the output movement of the output unit executes a rotation movement about a brake rotation axis and wherein the braking device comprises a second braking body which is arranged in a non-rotatable manner with respect to the drive housing and which comprises a second braking structure which lies opposite the first braking structure in the axis direction of the brake rotation axis, wherein a relative switch-over movement between the two braking bodies in the axis direction of the brake rotation axis is able to be created by way of the actuation device, said switch-over movement effecting a switch-over of the operating state of the braking device, wherein by way of the switch-over movement the two braking structures can be brought into braking engagement with one another or out of braking engagement for selectively creating the blocking position or the release position, wherein one of the two arm members is connected to the output unit and the other one of the two arm members is connected to the drive housing.
